(19) United States
(12) Patent Application Publication
(10) Pub. No.: US 2025/0162341 A1
(43) Pub. Date: May 22, 2025

(54) A Customizable Writing Instrument

(71) Applicant: Mopen LLC, Chandler, AZ (US)

(72) Inventors: Abhay Modi, Chandler, AZ (US); Marc Pendergraft, Chandler, AZ (US)

(21) Appl. No.: 18/838,973

(22) PCT Filed: Feb. 12, 2023
(86) PCT No.: PCT/US23/62449

§ 371 Date: Aug. 15, 2024

Related U.S. Application Data
(60) Provisional application No. 63/398,825, filed on Aug. 17, 2022.
(60) Provisional application No. 63/311,121, filed on Feb. 17, 2022.

(51) Int. Cl. B43K 8/00; B43K 21/00; B43K 27/00

(52) U.S. Cl. CPC B43K 8/003; B43K 21/006; B43K 27/003

(57) ABSTRACT

The invention is embodied in a customizable writing instrument. In many respects, this customizable writing instrument is similar to an ordinary writing instrument. The big difference is that this customizable writing instrument comprises a removable second barrel. The removable second barrel (or “sleeve”) allows the guts of the instrument to remain housed in the first barrel so no writing instrument pieces get lost during customization of the second barrel.

### FIELD OF THE INVENTION

The present invention relates to writing instruments. More specifically, this invention relates to customizing the barrel of a writing instrument.

### BACKGROUND

Customizing writing instruments is possible. But there are several problems. For example, when a crafter customizes a pen, the crafter typically removes the barrel from the rest of the pen. This results in a plurality of loose pen parts that tend to get lost if not stored carefully. The loose pen parts must be stored carefully so that the pen can be reassembled after customizing the barrel. Storing writing instrument parts is one problem.

Another problem is that writing instruments often have plastic barrels. Plastic barrels are not suitable for crafting because epoxy or sublimation can't be performed on them.

Another problem is that writing instruments often have clips. Clips interfere with crafting the writing instrument's barrel. For example, crafters often cut off the clips in order to customize a pen. Alternatively, crafters must customize around the clip, which is not preferable.

These problems are not limited to pens. Mechanical pencils and other writing instruments, like highlighters, can also suffer from these issues. What is needed is a solution that allows a crafter to customize most any writing instrument, from pens, to pencils to highlighters and more.

### SUMMARY OF INVENTION

The invention can be incorporated into a customizable writing instrument. For the purposes of this specification, a “writing instrument” broadly refers to a pen, a pencil, a highlighter and essentially any instrument used for marking that comprises an elongated barrel. The customizable writing instrument of this invention is similar in many respects to its conventional counterpart. One big difference is that the customizable pen of this invention comprises a removable second barrel.

The second barrel is positioned between a raised stop on one end of the instrument and a removable cap on the other end. In this way, the second barrel can be removed, customized and replaced on the instrument without having to disassemble the other parts of the instrument. This separable feature does two things. First, by removing the second barrel and then securing the barrel cap back on the first barrel, all the pieces of the writing instrument stay together. Second, removing the second barrel allows a crafter to customize the second barrel separate from the guts of the instrument. That way, if the crafting fails, the writing instrument is not lost. For a new, second barrel can go back on the instrument.

The preferred embodiment of the invention comprises a pen with straight walls, stainless steel parts, and no clips. This way, crafters don't have to cut the clip off and the pen does not have a fixed spot for the clip where it covers the customization. Optionally, removable clips can be added if desired. The preferred pen has a second barrel (or “sleeve”) that removably connects to the body so that a user can remove the sleeve to customize. This allows the guts of the pen to remain housed in the first barrel so no pen pieces get lost. Lastly, the stainless-steel body makes the pen durable and it allows for customizing the pens with epoxy and sublimation and eventually engraving.

This invention can also be incorporated into a customizable mechanical pencil, a customizable highlighter, and most any other writing instrument having first barrel. These alternative embodiments are discussed in the specification that follows.

### LIST OF DRAWINGS

FIG. 1 illustrates a preferred embodiment of the invention;

FIG. 2 illustrates the preferred embodiment of FIG. 1 with the barrel cap removed and the second barrel removed;

FIG. 3 illustrates a raised stop on the distal end;

FIG. 4 illustrates a preferred embodiment with the second barrel removed and the barrel cap connected to the proximal end. In addition, FIG. 4 illustrates a customized second barrel;

FIG. 5 illustrates a mechanical pencil embodiment of the invention;

FIG. 6 illustrates a view of the mechanical pencil embodiment of the invention with the second barrel removed;

FIG. 6 also illustrates replacement lead sticks and replacement erasers;

FIG. 7 illustrates a the proximal and distal ends of a mechanical pencil embodiment where the second barrel is on the pen and being held by the barrel cap on the proximal end and the raised stop on the distal end; and,

FIG. 8 illustrates the barrel cap removed from the proximal end, which allows the second barrel to slide off and be separated from the writing instrument.

### DETAILED DESCRIPTION OF THE PREFERRED EMBODIMENTS

A clear understanding of the key features of the invention is referenced to the appended drawings that illustrate the invention. It should be understood that such drawings depict preferred embodiments of the invention and, therefore, are not to be considered as limiting its scope regarding other embodiments that the invention is capable of contemplating.

The invention is embodied in a customizable writing instrument 10. FIG. 1 illustrates the preferred embodiment of a customizable pen. As shown, the pen comprises a barrel cap 12 on the proximal end and a raised stop 14 on the distal end. FIG. 1 also shows a second barrel 18. In FIG. 1, the second barrel 18 covers the first barrel 16.

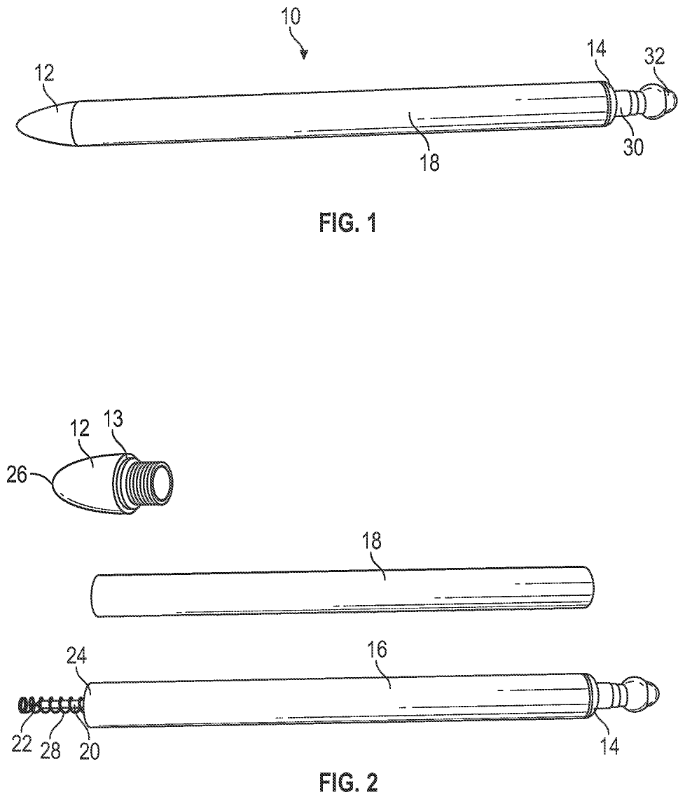

FIG. 2 illustrates the customizable instrument 10 with the barrel cap 12 and the second barrel 18 removed. Removing the second barrel 18 exposes a first barrel 16. Inside the first barrel 16 is an ink tube 20, the ink tube 20 is in fluid communication with a writing tip 22.

The barrel cap 12 removably mates with a proximal end 24 of the first barrel 16. Preferably, the barrel cap 12 removably mates by a threaded connection, but other connections known in the art would work. The barrel cap 12 has an opening 26 for the writing tip 22.

It is preferred that the barrel cap 12 comprise a diameter 13 that is equal to the outside diameter of the second barrel 18 to create a flush outside surface. At a minimum, it is important that the barrel cap 12 comprise a diameter 13 bigger than the inside diameter of the second barrel 18 so that the second barrel 18 cannot slip off the proximal end of the customizable writing instrument 10 when the barrel cap 12 is mated with the first barrel 16.

It is also important that the second barrel 18 comprise an inner diameter bigger than the outer diameter of the first barrel 16 so that the second barrel 18 can slide over the first barrel 16.

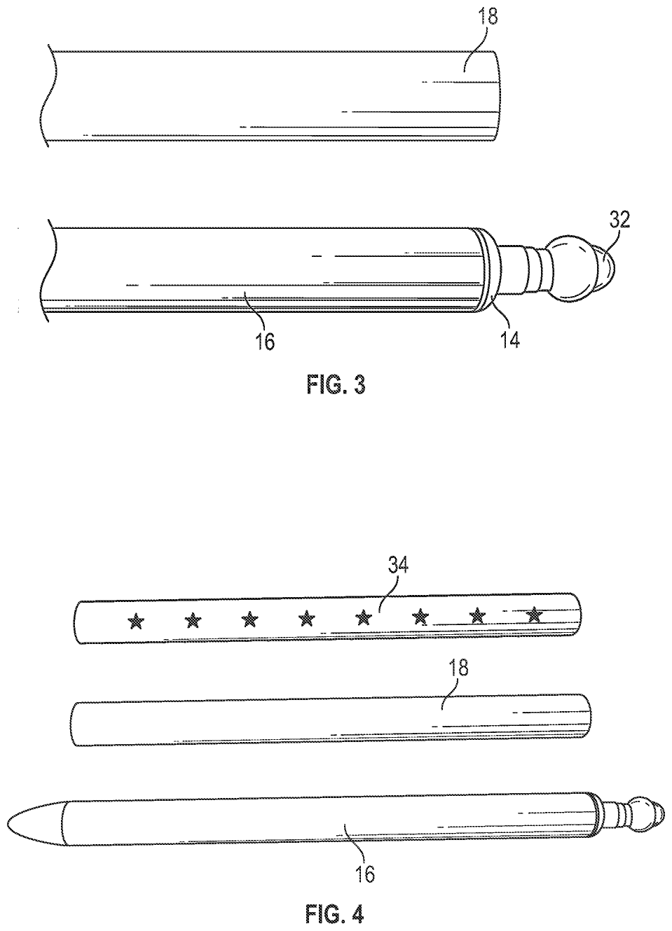

FIG. 3 illustrates a close up view of a stop 14 located on a distal end of the first barrel 16. It is preferred that stop 14 comprise a diameter that is equal to the outside diameter of the second barrel 18 to create a flush outside surface. At a minimum, it is important that the stop 14 comprise a diameter bigger than the inside diameter of the second barrel 18 so that when the second barrel 18 slides over the first barrel 16, the stop 14 keeps the second barrel 18 from slipping off the distal end of the customizable writing instrument 10. In this way, when the barrel cap 12 is mated to the first barrel 18, the second barrel 18 is confined between the stop 14 and the barrel cap 12 as shown in FIG. 1.

### Mechanical Pencil Embodiment

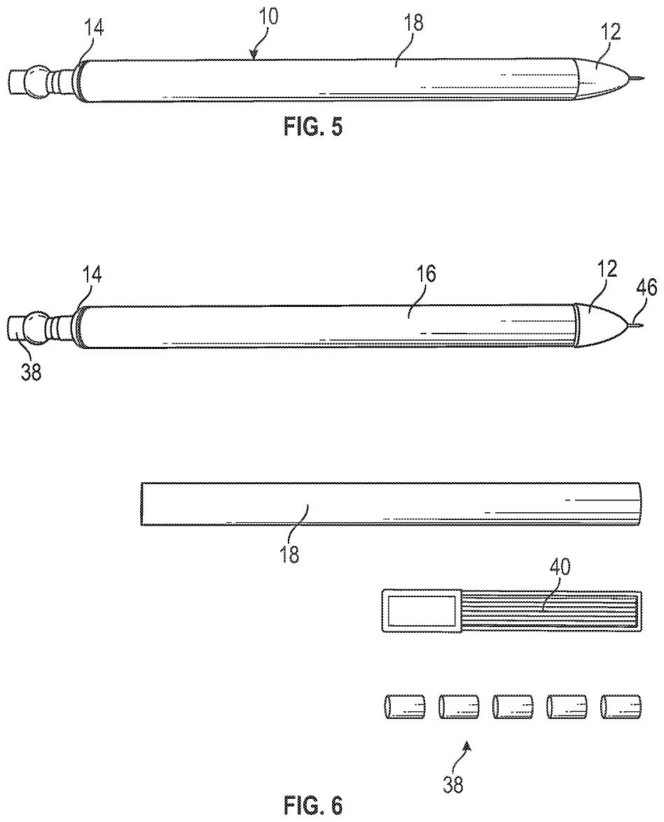

The mechanical pencil embodiment shown in FIGS. 5-8 operates in a similar way as the pen embodiment discussed previously. As shown, the writing instrument 10 comprises a barrel cap 12 on the proximal end and a raised stop 14 on the distal end. FIG. 5 also shows a second barrel 18. In FIG. 1, the second barrel 18 covers the first barrel 16.

FIG. 6 illustrates the customizable instrument 10 with the barrel cap 12 and the second barrel 18 removed. Removing the second barrel 18 exposes a first barrel 16. Inside the first barrel 16 is stick of pencil lead 36, the stick of pencil lead (or similar writing material) is preferably configured like an ordinary mechanical pencil to be capable of advancing through the hollow lead guide 46. For the purposes of this specification, the term “pencil lead” broadly refers to the material typically found in a pencil or mechanical pencil; that is, a mixture of graphite and clay.

The barrel cap 12 removably mates with a proximal end 24 of the instrument 10. Preferably, the barrel cap 12 removably mates by a threaded connection, but other connections known in the art would work. The barrel cap 12 has hollow lead guide 46 configured to permit the pencil lead to pass through.

It is preferred that the barrel cap 12 comprise a diameter 13 that is equal to the outside diameter of the second barrel 18 to create a flush outside surface. At a minimum, it is important that the barrel cap 12 comprise a diameter 13 bigger than the inside diameter of the second barrel 18 so that the second barrel 18 cannot slip off the proximal end of the customizable writing instrument 10 when the barrel cap 12 is mated with the first barrel 16.

It is also important that the second barrel 18 comprise an inner diameter bigger than the outer diameter of the first barrel 16 so that the second barrel 18 can slide over the first barrel 16.

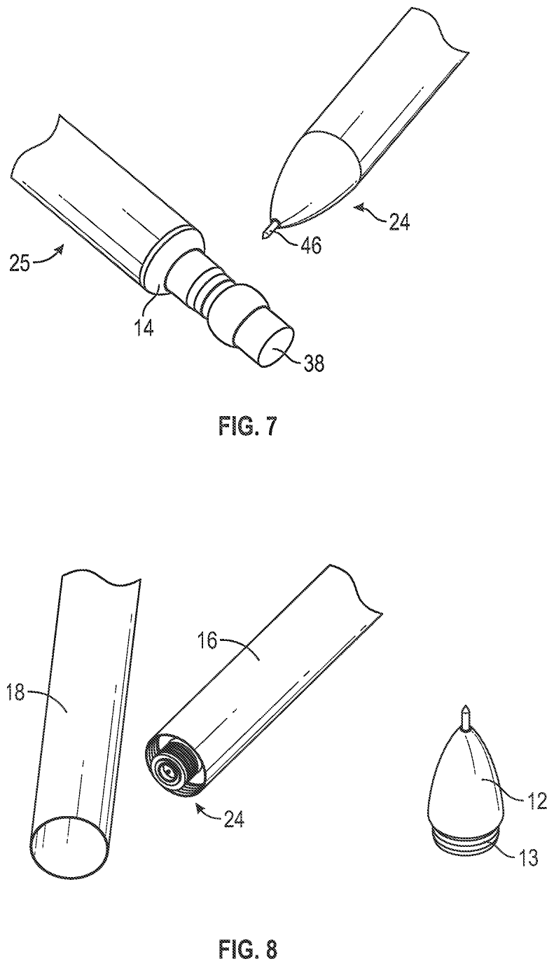

FIG. 7 illustrates a close up view of a stop 14 located on a distal end 25 of the writing instrument 10. It is preferred that stop 14 comprise a diameter that is equal to the outside diameter of the second barrel 18 to create a flush outside surface. At a minimum, it is important that the stop 14 comprise a diameter bigger than the inside diameter of the second barrel 18 so that when the second barrel 18 slides over the first barrel 16, the stop 14 keeps the second barrel 18 from slipping off the distal end of the customizable writing instrument 10. In this way, when the barrel cap 12 is mated to the first barrel 18, the second barrel 18 is confined between the stop 14 and the barrel cap 12 as shown in FIG. 1.

### Other Embodiments

The solution discussed above will work for writing utensils other than a pen or a pencil. It can work for a highlighter or any writing instrument that has first barrel 16, a removable cap on one end and a raised stop on the other. In this way, the removable cap can be removed to allow a second barrel 18 to slide over the first barrel 16 and be positioned between the removable cap and the raised stop so that it won't slip off.

### Optional Components

The customizable writing instrument 10 can optionally comprise other components often found on a writing instrument. For example, a spring 28, a clicker 30, and other miscellaneous pieces can optionally be employed to make the writing tip 22 retractable. Likewise, erasers 38 and lead re-fills 40 can also be utilized. These options are well-known in the art.

It is preferred that the writing instrument 10 comprise a stylus 32. A user can use the stylus 32 on a smart phone or ipad.

It is preferred that a writing instrument 10 does not have a clip.

The writing instrument 10 can also have more than a single second barrel (or “sleeve”) 18. Other barrels 34 (or “sleeves”) can be used to customize the writing instrument 10. The second barrel 18 can be removed for customization by the user. Likewise, if the user wants a different customization on the pen, the user can just get another second barrel 18 (i.e., a “third” barrel) save the current second barrel 18 for future use.

The ink tubes 20 (or “cartridges”), pencil lead sticks, highlighter ink pads and other materials typically used in writing instruments can also be interchangeable. For the purposes of this application, the terms ink tubes, cartridges, pencil lead sticks, and highlighter ink pads are sometimes collectively referred to as “marking elements.”

It is preferred to make at least the second barrel 18 from stainless steel. It is preferred to make the other exterior pieces from stainless steel, too. Among other things, the stainless-steel body makes the pen durable and it allows for customizing the pens with epoxy and sublimation and eventually engraving. The second barrel 18 (and even the first barrel 16) can be decorated by most any means known in the art of crafting.

In operation, the writing instrument 10 is similar to an ordinary writing instrument. The big difference is that this customizable writing instrument 10 comprises a removable second barrel 18. The second barrel 18 is configured to slide over the first barrel 16. The second barrel 18 is secured into place by a raised stop 14 on one end and a barrel cap 12 on the other end. A removable second barrel 18 enables a crafter to separate the second barrel 18 from the writing instrument 10. The feature does two things. First, by removing the second barrel 18 and then securing the barrel cap 12 back on the first barrel 16, all the interior pieces of the writing instrument 10 stay together. Second, removing the second barrel 18 allows a crafter to customize the second barrel 18 separate from the guts of the writing instrument 10. That way, if the crafting fails, the guts of the writing instrument 10 are not lost. A new second barrel 18 can go back on the pen.

The preferred embodiment of the invention comprises a pen with straight walls, stainless steel parts, and no clips. The preferred pen has a second barrel 18 (or “sleeve”) It attached to the body so you can remove the sleeve to customize. This allows the guts of the pen to remain housed in the first barrel so no pen pieces get lost.

The preferred embodiment of the invention does not have a clip. This way, crafters don't have to cut the clip off or the pen does not have a fixed spot for the clip where it covers the customization. Optionally, removable clips can be added if desired. Lastly, the stainless-steel body makes the pen durable and it allows for customizing the pens with epoxy and sublimation and eventually engraving.

What is claimed is:

1. A writing instrument comprising
a first barrel comprising an outer diameter,
a marking element housed within the first barrel, the marking element configured to protrude from a writing tip,
a barrel cap that removably mates with a proximal end of the first barrel, the barrel cap comprising an opening for the writing tip, the barrel cap comprising a diameter bigger than an inside diameter of a second barrel,
the inside diameter of the second barrel bigger than the outer diameter of the first barrel, the second barrel configured to slide over the first barrel,
a stop located on a distal end of the first barrel, the stop comprising a diameter bigger than the inside diameter of the second barrel,
wherein the second barrel can slide over the first barrel when the barrel cap is removed and be confined between the stop and the barrel cap when the barrel cap is mated to the first barrel.

2. A pen comprising
a first barrel comprising an outer diameter,
an ink tube housed within the first barrel, the ink tube in fluid communication with a writing tip,
a barrel cap that removably mates with a proximal end of the first barrel, the barrel cap comprising an opening for the writing tip, the barrel cap comprising a diameter bigger than an inside diameter of a second barrel,
the inside diameter of the second barrel bigger than the outer diameter of the first barrel, the second barrel configured to slide over the first barrel,
a stop located on a distal end of the first barrel, the stop comprising a diameter bigger than the inside diameter of the second barrel,
wherein the second barrel can slide over the first barrel when the barrel cap is removed and be confined between the stop and the barrel cap when the barrel cap is mated to the first barrel.

3. A pencil comprising
a first barrel comprising an outer diameter,
a stick of pencil lead housed within the first barrel, the stick configured to protrude from a writing tip,
a barrel cap that removably mates with a proximal end of the first barrel, the barrel cap comprising an opening for the writing tip, the barrel cap comprising a diameter bigger than an inside diameter of a second barrel,
the inside diameter of the second barrel bigger than the outer diameter of the first barrel, the second barrel configured to slide over the first barrel,
a stop located on a distal end of the first barrel, the stop comprising a diameter bigger than the inside diameter of the second barrel,
wherein the second barrel can slide over the first barrel when the barrel cap is removed and be confined between the stop and the barrel cap when the barrel cap is mated to the first barrel.
